(19) United States
(12) Patent Application Publication
(10) Pub. No.: US 2013/0321446 A1
(43) Pub. Date: Dec. 5, 2013

(54) Methods And Systems For Visualizing Data

(71) Applicant: The Board of Trustees of the University of Illinois, Urbana, IL (US)

(72) Inventors: Joel E. Cutcher-Gershenfeld, Champaign, IL (US); Michael Haberman, Mahomet, IL (US); J. Mark Nolan, Urbana, IL (US)

(21) Appl. No.: 13/907,291

(22) Filed: May 31, 2013

Related U.S. Application Data
(60) Provisional application No. 61/654,556, filed on Jun. 1, 2012.

(51) Int. Cl. G06T 11/20

(52) U.S. Cl. CPC G06T 11/206
USPC 345/589; 345/440

(57) ABSTRACT

A visualization system generates a visualization for a data set comprising multiple data points. The visualization system accesses the data set and determines a representative data characteristic of the data set. The visualization system also determines, for each of the multiple data points in the data set, a difference between a data point value of a respective data point and the representative data characteristic. Using the determined differences, the visualization system determines a plotting order of the multiple data points. To generate the visualization, the visualization system plots the representative data characteristic in an initial cell and plots the multiple data points in the data set in respective cells such that the respective cells spiral outward from the initial cell in the determined plotting order.

### CROSS REFERENCE TO RELATED APPLICATIONS

This application claims the benefit of and incorporates by reference in its entirety U.S. Provisional Patent Application Ser. No. 61/654,556, filed on Jun. 1, 2012, and titled “Stakeholder Alignment In Sociotechnical Systems.”

### FEDERALLY SPONSORED RESEARCH OR DEVELOPMENT

This invention was made with government support under contract number NSF-VOSS 0956472 awarded by the National Science Foundation. Subsequent NSF support associated with the invention occurred under NSF-OCI 1229928 and NSF-SciSPR-STS-OCI-INSPIRE 1249607, The U.S. Government has certain rights in this invention.

### TECHNICAL FIELD

This disclosure relates to methods and systems for data visualization.

### BACKGROUND

Advances in technology have resulted in computing devices with continually increasing processing capability, speed, and efficiency. Modern computing devices can process immense amounts of data. Additionally, data analysis processes are becoming increasing complex, and data sets are continually increasing in size. Additionally, data is being generated with respect to complex phenomena not always effectively visualized with existing tools and methods. In certain situations, it is advantageous to view data at finer granularities, particularly when each data point in even large data sets is important or impactful.

### SUMMARY OF THE INVENTION

In one aspect, a method for data visualization may be performed through a visualization system comprising a processor by: accessing a data set comprising multiple data points; determining a representative data characteristic of the data set; determining, for each of the multiple data points in the data set, a difference between a data point value of a respective data point and the representative data characteristic; and generating a visualization of the data set. The visualization of the data set may be generated by plotting the representative data characteristic in an initial cell and plotting each of the multiple data points in the data set in respective cells such that the respective cells spiral outward from the initial cell in an order based on the distance (e.g., difference) between the data point value of the respective data point and the representative data characteristic.

In another aspect, a system includes a memory storing a data set comprising multiple data points and visualization logic in communication with the memory. The visualization logic is configured to access the data set from the memory; determine a representative data characteristic of the data set; determine, for each of the multiple data points in the data set, a difference between a data point value of a respective data point and the representative data characteristic; determine a plotting order for the multiple data points based on the determined difference for the multiple data points; and generate a visualization of the data set. The visualization logic generates the visualization of the data set by plotting the representative data characteristic in an initial cell and plotting each of the multiple data points in the data set in respective cells such that the respective cells spiral outward from the initial cell in the determined plotting order.

In another aspect, a product includes a computer readable medium storing processor executable instructions. When executed, the processor executable instructions cause a system to access a data set comprising multiple data points; determine a representative data characteristic of the data set; determine, for each of the multiple data points in the data set, a difference between a data point value of a respective data point and the representative data characteristic; determine a plotting order for the multiple data points based on the determined difference for the multiple data points; and generate a visualization of the data set. The processor executable instructions cause the system to generate the visualization by plotting the representative data characteristic in an initial cell and plotting each of the multiple data points in the data set in respective cells such that the respective cells spiral outward from the initial cell in the determined plotting order.

### BRIEF DESCRIPTION OF THE DRAWINGS

The innovation may be better understood with reference to the following drawings and description. In the figures, like reference numerals designate corresponding parts throughout the different views.

FIG. 1 shows an example of a system for visualization.

FIG. 2 shows an example of an initial state of a z-flower™ visualization.

FIG. 3 shows an example of an intermediate state of a z-flower™ visualization.

FIG. 4 shows an example of a state of a z-flower™ visualization.

FIG. 5 shows an example of a z-flower™ visualization.

FIG. 6 shows an example of a z-flower™ visualization.

FIG. 7 shows additional examples of z-flower™ visualizations.

FIG. 8 shows an example of logic that the visualization logic may implement as hardware, software, or firmware.

FIG. 9 shows an example of a system for presenting a z-flower™ visualization.

FIG. 10 shows an example of a visual analog scale.

FIGS. 11A-11C show examples of z-flower™ visualizations.

FIGS. 12A-12F show examples of z-flower™ visualizations.

FIG. 13 shows examples of z-flower™ visualizations.

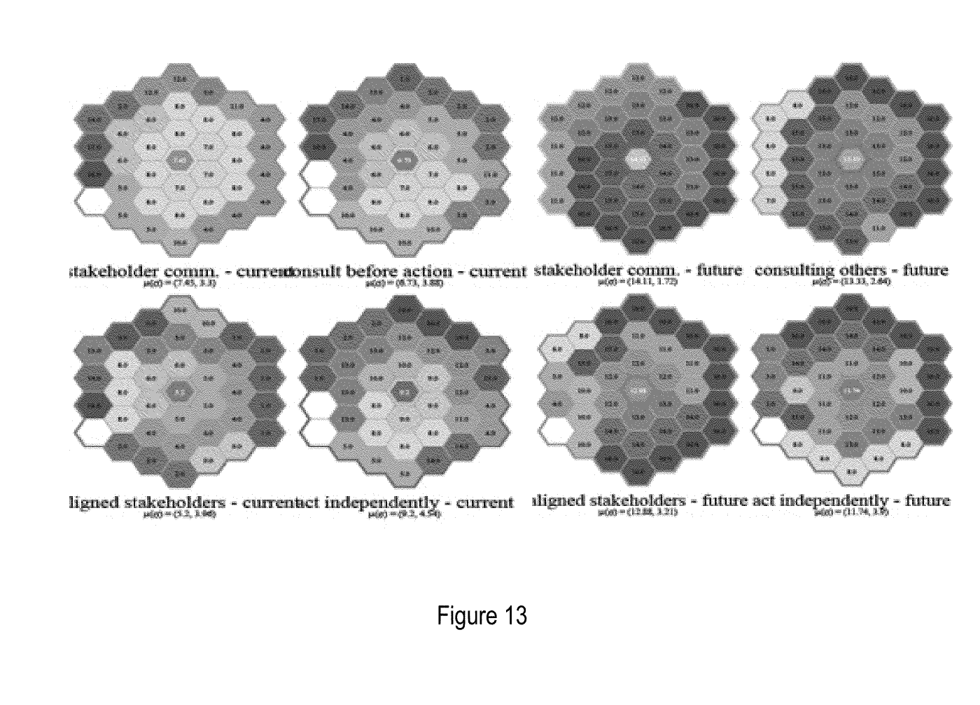

FIGS. 14A-14B show examples of z-flower™ visualizations.

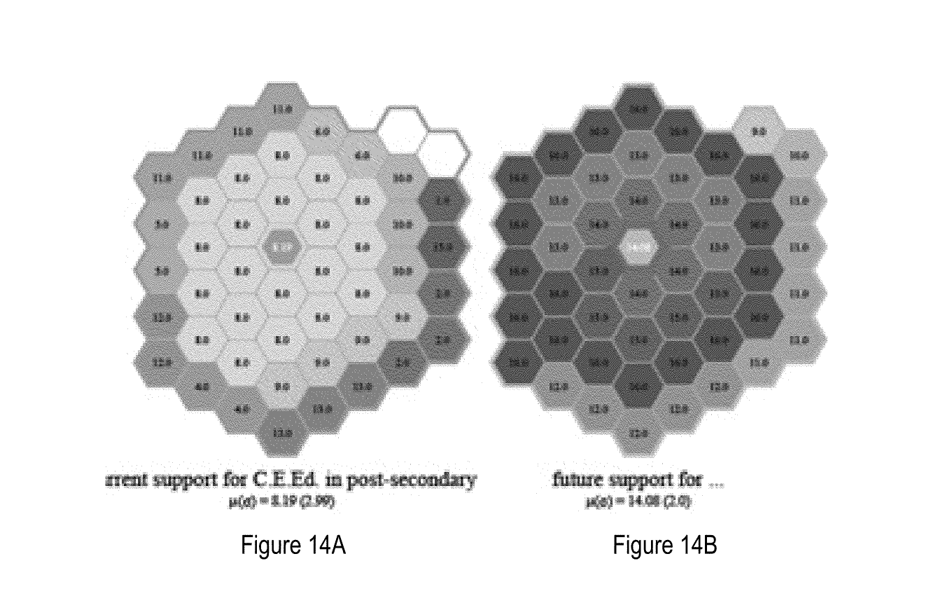

FIGS. 15A-15B show examples of z-flower™ visualizations.

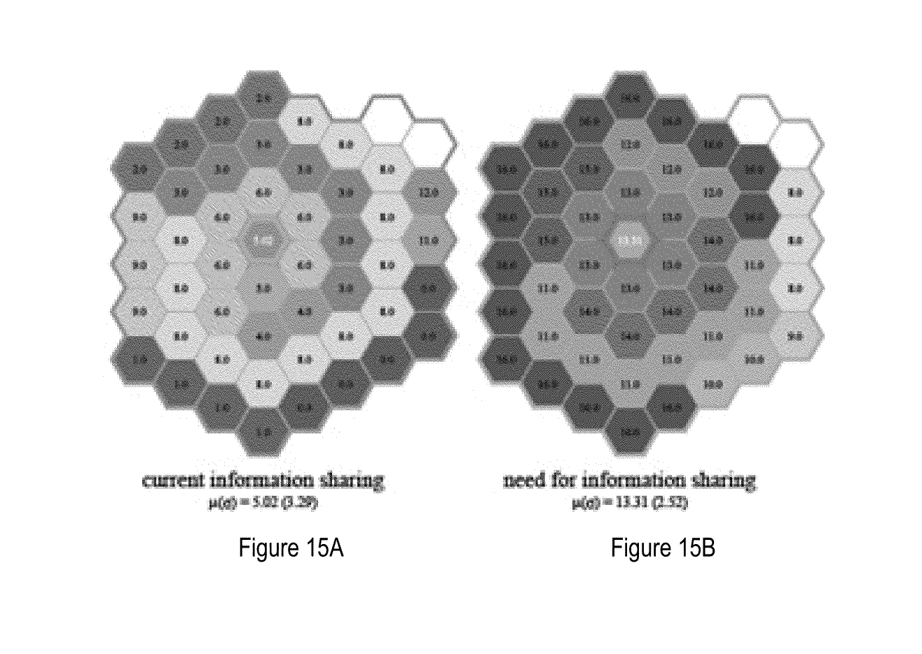

FIGS. 16A-16B show examples of z-flower™ visualizations.

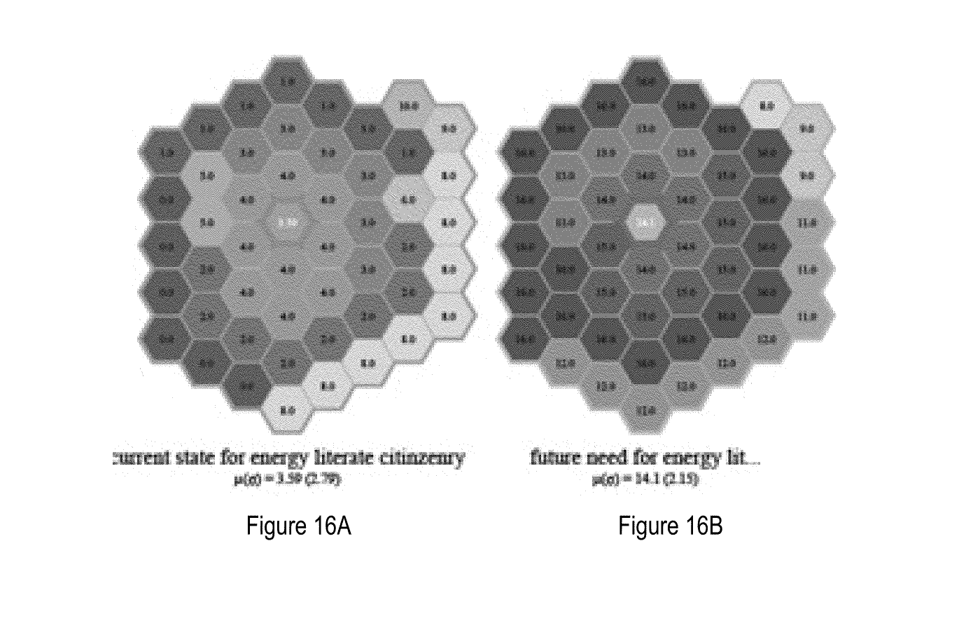

### DETAILED DESCRIPTION

The discussion below refers to a z-flower™ visualization. A z-flower™ visualization may refer to a particular visual format for presenting data using a spiraling of cells from an initial cell. As described below, the z-flower™ visualization may efficiently and effectively visualize the data from the data set and may be used to effectively represent each data point in the data set. In that regard, the z-flower™ visualization may provide a quick view or mapping of a corresponding data value for each data point in a data set and/or one or more representative data characteristics of the data set (e.g., mean, mode, standard deviation, etc.). The z-flower™ visualization may also efficiently and effectively represent a distribution of data points in the data set. The z-flower™ visualization may additionally or alternatively visualize other characteristics, attributes, values, or dimensions of the data set. One example of a z-flower™ visualization is a z-flower™ chart that graphically represents the data set, e.g., as described herein.

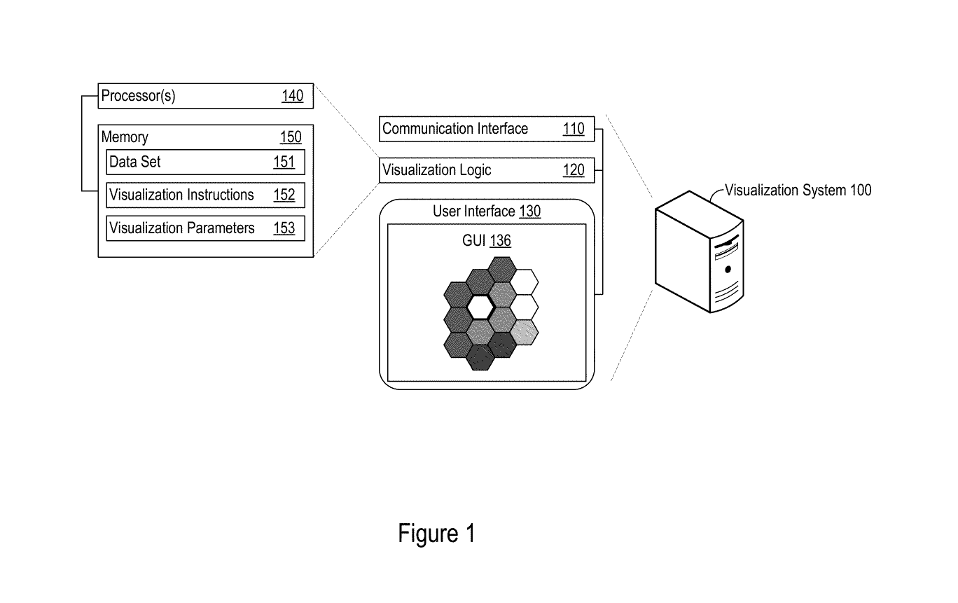

FIG. 1 shows an example of a system for visualization system 100. The visualization system 100 includes a communication interface 110, visualization logic 120, and a user interface 130. The visualization logic 120 may include any combination of hardware, software, firmware, or other logic. The visualization logic 120 may be implemented, for example, in a system on a chip (SoC), application specific integrated circuit (ASIC), or other circuitry. The system logic 120 is part of the implementation of any desired functionality in the visualization system 100.

The communication interface 110 may be configured to communicate across any number of communication networks, including communication networks that support various properties, e.g., quality-of-service (QoS), network technologies, network standards, network topologies, encoding formats, physical (PHY) interfaces, and more. For example, a communication interface may communicate according to any of the following network technologies, topologies, mediums, or and standards: Ethernet, cable (e.g. DOCSIS), DSL, Multimedia over Coax Alliance (MoCA), power line (e.g. HomePlug AV), Ethernet Passive Optical Network (EPON), Gigabit Passive Optical Network (GPON), any number of cellular standards (e.g., 2G, 3G, Universal Mobile Telecommunications System (UMTS), GSM (R) Association, Long Term Evolution (LTE) (TM), or more), WiFi (including 802.11 a/b/g/n/ac), WiMAX, Bluetooth, WiGig, and others.

In one implementation, the visualization logic 120 includes one or more processors 140 and a memory 150. The memory 150 stores, for example, a data set 151, visualization instructions 152, and visualization parameters 153. The processor 140 may execute the visualization instructions 152 to access the data set 151 and visualize some or all portions or aspects of the data set 151 according to the visualization parameters 153. In particular, and as described in greater detail below, the visualization logic 120 may generate and present a z-flower™ visualization of the data set 151 or particular aspects thereof. For example, the user interface 130 of the visualization system 100 may include a graphical user interface (GUI) 136 through which the visualization logic 120 may present a z-flower visualization.

The visualization logic 120 may generate a z-flower visualization for virtually any data set 151, including discrete numerical values, continuous numerical values, and/or categorical data value, e.g., visualizing data arranged or distinguished by category, when a particular category or type of data is assigned a particular numerical value. As one continuing example presented below, the data set 151 may represent responses from stakeholder interviews for one or more issues, obtained from identified stakeholders and used as part of a stakeholder alignment process in sociotechnical systems, e.g., attitudes, interests, and/or beliefs of individual or entity stakeholders. As another example, the data set 151 may be weather pattern data for a particular location over an hourly, weekly, monthly, yearly basis or for any other configurable time period. The data set 151 may track performance data for a company, e.g., sales, profit margins, growth data, etc. Additional exemplary data sets 151 include power consumption data for a particular power meter, building unit, or geographical region, traffic pattern data for a street, neighborhood, or city, network bandwidth data, cell phone coverage data, or various other forms of data sets 151 with discrete data values. The visualization could be used with biological or chemical or other scientific observations in order to visualize responses, for example, to a given treatment or circumstance.

As mentioned above, the z-flower™ visualization may efficiently and effectively visualize the data from the data set 151. In that regard, the z-flower™ visualization may provide a quick view or mapping of a corresponding data value (or data point value) for each data point in the data set 151 and/or one or more representative data characteristics of the data set (e.g., mean, mode, standard deviation, etc.). The z-flower™ visualization may additionally or alternatively visualize other characteristics, attributes, values, or dimensions of the data set 151. For example, in visualizing stakeholder responses to a particular issue, a z-flower™ visualization may additionally visualize one or more demographic characteristics of the stakeholders as well, such as gender, public vs. private stakeholders, organizational or sub-organizational characteristics, age or age range or responding stakeholders, and/or any other characteristic of the stakeholders.

The z-flower™ visualization may visualize each data point in the data set 151, in contrast to aggregating the representation of the data set 151 through descriptive statistics or reducing to the data set 151 to a lower dimension. Accordingly, the z-flower™ visualization provides insight to the entirety of the data set 151, which may be valuable when each data point is individually impactful. The z-flower™ visualization, in that regard, also maps the relationship between individual data points in the data set 151, even for large scale data sets 151 with tens, to hundreds, to thousands of data points. In some implementations, the z-flower™ visualization may visualize data points with a null value or without a corresponding data value. Continuing the shareholder alignment example, the z-flower™ visualization may visualize when one or more stakeholders failed to respond or indicated “Not Applicable” for a particular issue. When all the shareholder data (or other data in other uses of the z-flower™ visualization) is visually represented in this way, effective responses can be elicited from relevant audiences that would not happen with other methods of displaying data

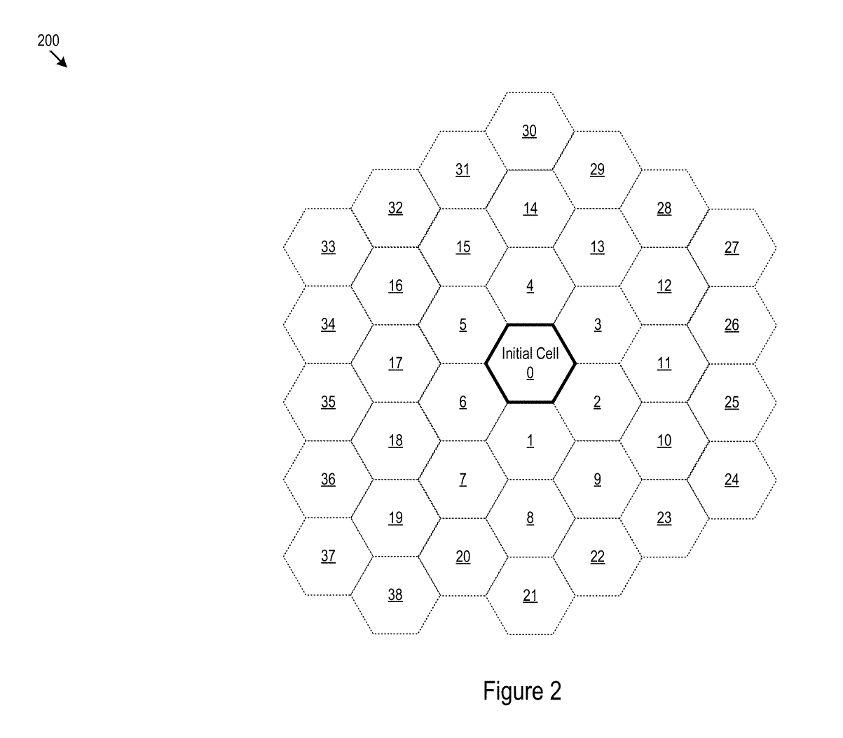

Next, an exemplary process for generating a z-flower™ visualization is presented. FIGS. 2-5 provide exemplary states of the z-flower™ visualization during the generation process. The exemplary process is presented in the context of stakeholder alignment, and the data set 151 includes stakeholder responses for a particular issue obtained through stakeholder interviews. While one exemplary stakeholder alignment data set 151 is presented, the visualization logic 120 may similarly or consistently generate a z-flower™ visualization for various other data sets 151 as well. Multiple visualization options are presented, which may be specified or configured using the visualization parameters 153.

The visualization logic 102 may obtain or access the data set 151. In some implementations, the visualization system 100 may obtain the data set 151 through the communication interface 110, e.g., from a remote network device that collected the data set 151 or as inputs through the user interface 130. The visualization system 100 may store the data set 151 in the memory 150. In this particular stakeholder alignment example, the data set 151 includes responses from 38 stakeholders in an organization for a particular issue. The 38 responses may be stored in the data set 151 as discrete numerical values.

The responses may be obtained through a visual analog scale presented to the interviewed stakeholders. As one example, the visual analog scale may range from “Completely Agree” at one spectrum end to “Completely Disagree” at the other spectrum end. The analog visual scale may be color coded, for example with a white color at one spectrum end to a black color at the end spectrum end, blending between into various shades of gray indicative of a level of agreement and/or proximity to the spectrum ends. As another example, the analog visual scale spectrum may be colored red at one spectrum end, blending into a yellow color at the midpoint of the spectrum, and further blending into a green color at the other end of the analog visual scale spectrum. Any number of color combinations and codings are contemplated. The analog visual scale may include numerical values, e.g., radio buttons ranging from 0.0 to 16.0 with 1.0 increments between buttons. Alternatively, the analog visual scale may include no numerical values, and the stakeholder may select a point on the spectrum representative of their response. The visualization logic 120 may convert responses obtained through a visual analog scale into corresponding numerical values.

In this particular stakeholder alignment z-flower™ visualization example, the data set 151 includes 38 responses, one for each of the interviewed stakeholders. The data set 151 may include the following 38 response values ranging from 0.0-16.0 and data points where a stakeholder provided no answer:
{15.0; 13.0; 14.0; 16.0; 16.0; 13.0; 13.0; 12.0; 10.0; 16.0; 16.0; 16.0; 12.0; 14.0; 14.0; 16.0; 14.0; 5.0; 14.0; 11.0; No Answer; 11.0; 10.0; 16.0; 16.0; 14.0; 13.0; 16.0; 16.0; 14.0; 5.0; 0.0; 16.0; 15.0; 16.0; 0.0; No Answer; 10.0}
   The visualization logic 120 may generate a z-flower™ visualization from this 38 point data set 151.

FIG. 2 shows an example of an initial state 200 of a z-flower™ visualization. The initial state 200 may illustrate one exemplary form of a z-flower™ visualization. The initial state 200 of the z-flower visualization includes multiple cells, one for each 38 data point in the data set 151 as well as an initial cell 0. The visualization logic 120 may plot the initial cell 0 according to the visualization parameters 153. For example, the visualization logic may determine one or more representative data characteristics of the data set 151 to plot within the initial cell 0. Representative data characteristics can include a mean of data values in the data set 151, a mode, a median, standard deviation, or any other determined data characteristics. In some implementations, the visualization logic 120 plots a first data point in the initial cell 0. In the particular example shown in FIGS. 2-5, the visualization logic 120 determines the mean of the 38 responses from the stakeholder interviews stored in the data set 151. Specifically, the visualization logic 120 determines the mean based on the 36 response with discrete numerical values and does not account for the two “No Answer” responses, thus determining a mean value of 12.72.

To generate the z-flower™ visualization, the visualization logic 120 may plot the 38 data points of the data set 151 in the cells labeled 1-38 in FIG. 2. In particular, the visualization logic 120 may plot each of the data values for the data set 151 in a spiraling fashion, e.g., spiraling out from the initial cell 0 according to the numbering of the cells from 1 to 38. In the example shown in FIG. 2, a first cell 1 is located underneath the initial cell 0, but the visualization logic 120 may start the spiral out from the initial cell 0 at any other of the directly adjacent cells (e.g., those labeled as cells 2, 3, 4, 5, or 6 in FIG. 2). The visualization logic 120 may plot the data values of the data set 151 spiraling outward in either a clockwise or counter-clockwise manner.

The visualization logic 120 may determine a plotting order for the data points of the data set 151 for plotting in spiraling fashion of the z-flower visualization 120. The visualization logic 120 may determine the plotting order according to the visualization parameters 153, which may specify any particular ordering of the data points in the data set 151. The plotting order may also be referred to as a vector, e.g., an ordered vector of data points and/or associated data values for the data set 151. The visualization logic 120 may determine the plotting order based on the distance of the data point value of a data point from the determined representative data characteristic. Thus, in one implementation, the visualization logic 120 determines the plotting order of data points as an increasing order according to the distance (e.g., difference) between the data point value of a respective data point and the representative data characteristic. In the continuing stakeholder alignment example, the visualization logic 120 may determine the plotting order as the difference between the particular response value for a particular data point in the data set 151 and the 12.72 mean value of the data 151. The visualization logic 120 may determine the plotting order such that the data points with a null value or no data value (e.g., “No Answer”) are placed at the end of the plotting order.

The visualization logic 120 may determine that some of the data points in the data set 151 are equidistant from the determined representative data characteristic, but in different directions. For example, the visualization logic 120 may determine the distance from a mean value of the data set 151 for multiple particular data points is the equal in absolute value but different in sign (e.g., a difference of +0.5 and a −0.5 respective). In this situation, the visualization logic 120 may determine the plotting order such that data points that are greater

In the continuing stakeholder alignment example, the visualization logic 120 may determine the following plotting order (or vector) for the 38 responses in the data set 151:
{13.0; 13.0; 13.0; 13.0; 12.0; 12.0; 14.0; 14.0 14.0; 14.0; 14.0; 14.0; 14.0; 11.0; 11.0; 15.0; 15.0; 10.0; 10.0; 10.0; 16.0; 16.0; 16.0; 16.0; 16.0; 16.0; 16.0; 16.0; 16.0; 16.0; 16.0; 16.0; 5.0; 5.0; 0.0; 0.0; No Answer; No Answer}

The visualization parameters 153 may specify additional or alternative plotting orders as well, including as an increasing or decreasing order of the respective data value of the multiple data points, as an increasing order of the absolute value of the difference between the data point value of a respective data point and the representative data characteristic, etc. The plotting order may be user configurable as well.

In some implementations, the visualization logic 120 may perform one or more data processing techniques before, during, or after determining the plotting order. As one example, the visualization logic 120 may normalize the data set 151 into a predetermined value rage, e.g., from −1.0 to 1.0 which may include reserving the −1.0 value for missing or incomplete data points in the data set 151. Any other normalization parameters may be configured and applied through the visualization parameters 153.

The visualization logic 120 may determine the number of cells in the z-flower™ visualization according to the visualization parameters 153. The number of cells determined by the visualization logic 120 may vary according to the number of data points in the data set 151 the visualization logic 120 is generating a z-flower™ visualization for. In some implementations, the visualization logic 120 determines the number of cells in the z-flower™ visualization to be 1+the number of data points in the data set 151. In this way, the visualization logic 120 allocates one cell for each data point in the data set 151, thus individually visualizing each data point in the data set 151. For instance, in FIG. 2, the initial state 200 of the z-flower™ visualization includes 39 total cells, i.e., the initial cell 0 to plot the mean of the 38 point data set 151 and the 38 data cells, one for each of the data points in the 38 point data set 151. In other implementations, the visualization logic 120 determines the number of cells to be the number of data points in the data set 151, and foregoes plotting the initial cell 0 with the representative data characteristic. The term “z-Flower™” derives from an initial intention to convert data to what are termed “z scores” with a mean of zero and a standard deviation of one. As indicated above, z-Flower™ can be generated around initial points calculated in multiple ways and the spiraling out from that reference point can also happen in multiple ways.

The visualization logic 120 may generate a z-flower™ visualization according to any number z-flower™ cell numbering visualization parameters 153. For instance, the visualization parameters 153 may specify a threshold number of cells or threshold number of data points to plot in a z-flower™ visualization. In this instance, the visualization logic 120 may omit plotting some of the data points in the data set 151 according to the maximum cell or data point threshold value, e.g., by selecting a representative portion or the data set 151 and/or by representing multiple, identical data values in the same cell according, e.g., where each cell represents two instances of the data value occurring in the data set 151.

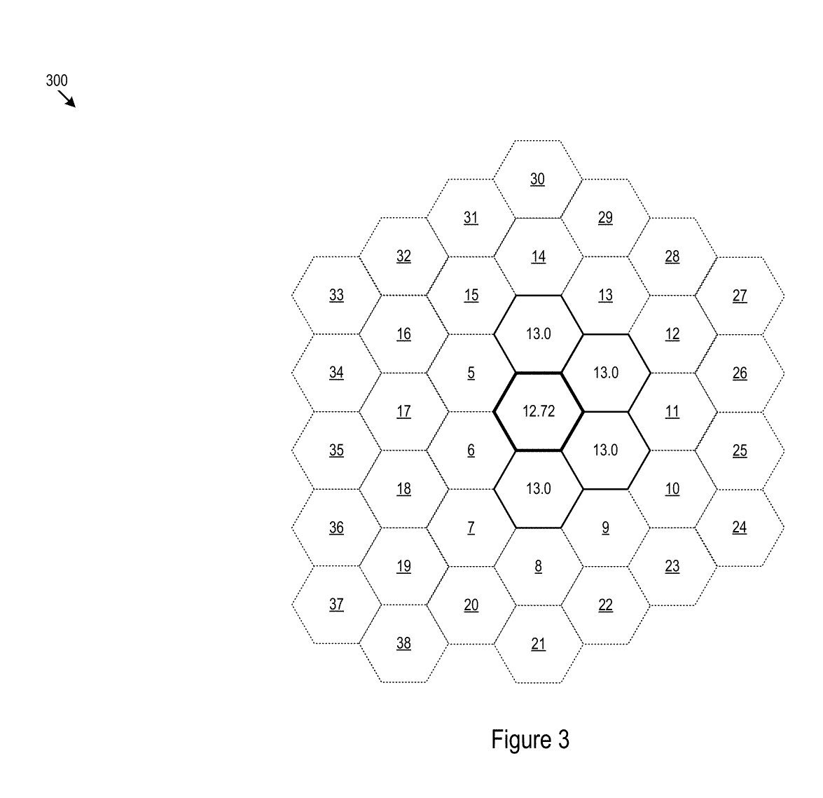

Continuing the z-flower™ visualization generation process, FIG. 3 shows an example of an intermediate state 300 of a z-flower™ visualization. In particular, FIG. 3 shows an intermediate state 300 after the visualization logic 120 has plotted the initial cell 0 with the representative data characteristic value of the data set 151 (e.g., the mean 12.72 for this particular data set 151) and the first four data points in the 38 point data set 151. As seen in FIG. 3, the visualization logic 120 determines the stakeholder responses with data values of 13.0 to be the data points with corresponding data values that have the least difference (absolute value) with the determined mean value of 12.72. These four data points with values of 13.0 are plotted in cells 1-4 respectively.

In a consistent manner, the visualization logic 120 may plot the remaining data points in the data set 151 in the spiraling manner and according to the determined plotting order. Thus, the visualization logic 120 plots the cells in the z-flower™ visualization labeled as 5-38.

In plotting data points in the z-flower™, the visualization logic 120 may apply a visual indication to the cell assigned to the particular data point. The visual indication may be indicative of the data value of a particular data point associated with the particular cell. In FIG. 3, the visualization logic 120 applies a numerical indication of the data value for the initial cell 0 and the data cells, as seen by the initial cell being labeled with the mean value 12.72 and the first four cells labeled with the data value 13.0. The visualization logic 120 may apply other additional or alternative visual indications as well, including indications based on color, line pattern, 3-dimensional effect, visual effect (e.g., graphics for rotating of cells, flashing of cells, or other visual effects, etc.), and more. In various implementations, some described below, the visualization logic 120 may apply additional visual indications to one or more of the z-flower™ visualization cells, which may be indicative of other characteristics of the respective data point (e.g., a demographic characteristic different from the data point value of the data point).

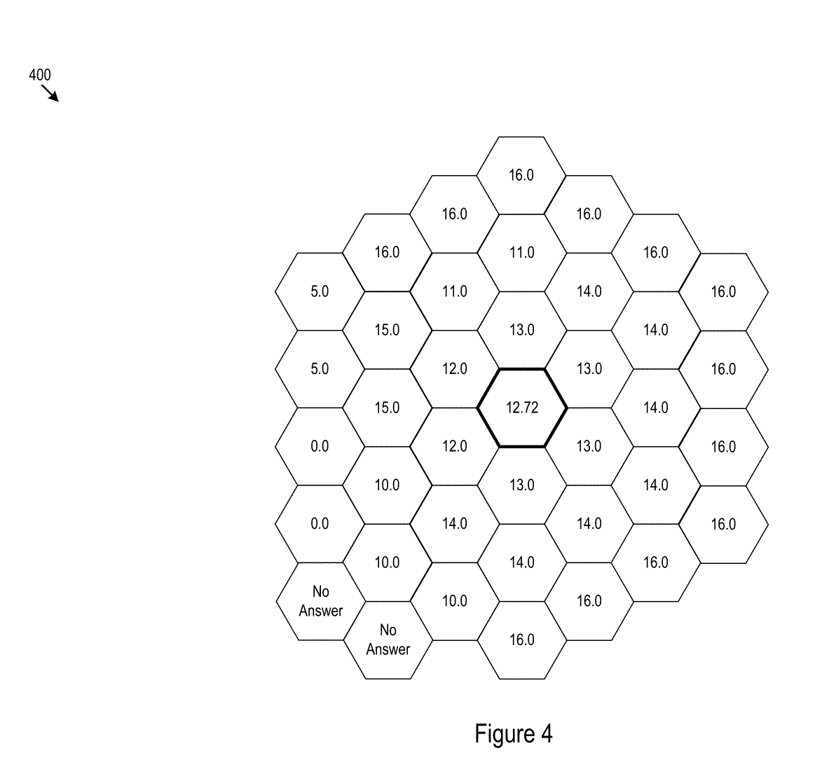

FIG. 4 shows an example of a state 400 of a z-flower™ visualization. The state 400 may be an intermediate state of the z-flower™ visualization, such as when the visualization parameters 153 specify applying one or more additional visual indications to cells of the z-flower™ visualization. In some circumstances, specified by the visualization parameters 153, FIG. 4 may illustrate final state of the z-flower™ visualization. As seen in FIG. 4, the visualization logic 120 plots the 38 data points of the stakeholder alignment data set 151 spiraling from the initial cell plotting the 12.72 mean value of the data set 151. The visualization logic 120 plots the data points according to the generated plotting order, which an increasing order according to the difference between the data point value of a particular data point and the 12.72 mean value. The two “No Answer” stakeholder responses are plotted at the end of the spiral, as these two responses are positioned at the end of the determined plotting order.

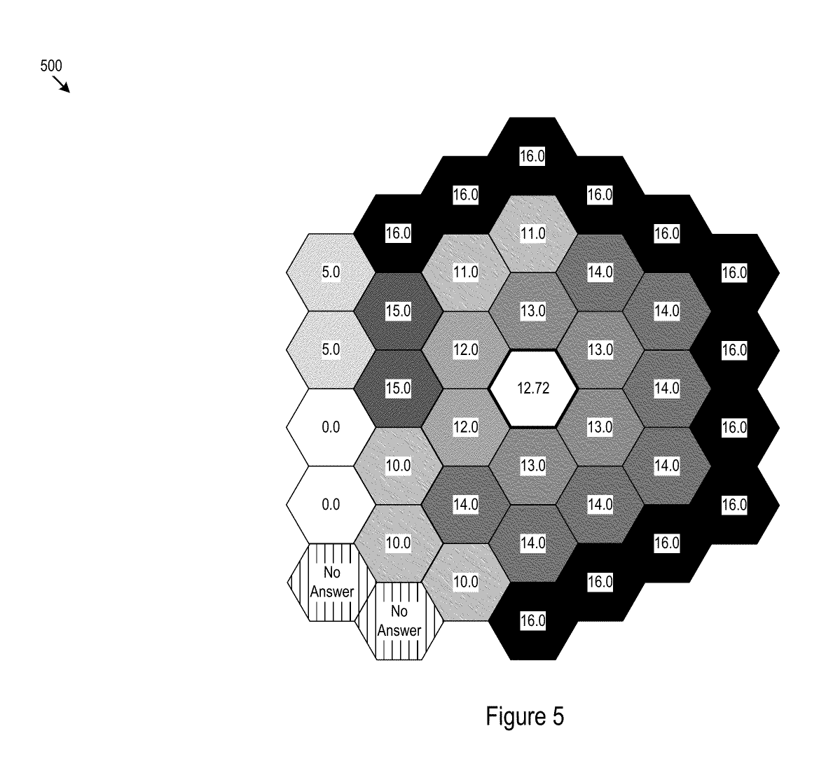

FIG. 5 shows an example of a z-flower visualization 500. In FIG. 5, the visualization logic 120 applies multiple visual indications for each cell in the z-flower visualization. The visualization logic 120 may apply, as an additional or alternative visual indication, a coloring to data cells. The visualization logic 120 may apply a coloring indicative of the data value of the data point plotted in cells of the z-flower™ visualization. For example, the visualization logic 120 may apply the coloring corresponding to the visual analog scale from which a data set 151 is obtained from. Alternatively, a different or variant coloring scheme may be employed. In FIG. 5, the visualization logic 120 applies a white to black coloring scheme, with response values of 0.0 at one end of the spectrum having a white color, response values of 16.0 at the other end of the spectrum having a block color, and the remaining response values positioned between having a shaded gray color based on a point in the spectrum the particular response value is located. The visualization logic 120 may apply a coloring pattern with respect to the shade of a cell or portion within the cell, to an outline of the cell (e.g., including weight and thickness of the outline), or in various other ways.

In addition or as an alternative to the coloring or numerical visual indication described above, the visualization logic 120 may apply various other visual indications, some of which are presented next. As a first example, the visualization logic 120 may apply text as a visual indication. In FIG. 5, the visualization logic 120 plots the last two cells in the spiral pattern with the words “No Answer,” indicative of the lack of response from 2 out of the 38 stakeholders. The visualization logic 120 may apply any additional or alternative textual indications, including symbols, special characters, code words, etc.

The visualization logic 120 may apply a line pattern as a visual indication to a z-flower™ cell. As illustrated in FIG. 5, the visualization logic 120 applies a line pattern to the last two “No Answer” cells in the spiral pattern of the z-flower™. The visualization logic 120 may also apply line patterns indicative of a data value, e.g., varying a concentration of lines in a cell based on the data value where a sparser concentration of lines is applied for lesser data values and a denser concentration of lines is applied for higher data values. Or, the visualization logic 120 may apply different line patterns for each data value in a data set 151, e.g., as specified or identified through a line pattern key.

As another example of a visual indication, the visualization logic 120 may apply a dimensional indication to a z-flower™ cell. For instance, In FIG. 5, the cells of the z-flower™ visualization are two-dimensional. The visualization logic 120 may apply a 3-dimensional effect to the z-flower™ cells, e.g., by adding a height effect to the z-flower cells, which may be indicative of a particular characteristic associated with the respective data point of the z-flower™ cells. As one example, the visualization logic 120 may apply a 3-dimensional height effect so that cells with a first height indicate the stakeholder responder was a male and cells with a second height indicate the stakeholder responder was a female. Or, the visualization logic 120 may apply a 3-dimensional height effect where the height of a particular cell is indicative of a positional level or level of influence of the particular stakeholder responder. The visualization logic 120 may employ any number of 3-dimensional effect configurations.

Continuing the examples of visual indications, the visualization logic 120 may apply an active visual effect to one or more cells of the z-flower™ visualization. The visualization logic 120 may apply, as examples, a rotating effect, blinking effect, tiling effect, or other active visual effect to the cell. The rate, direction, duration, or other characteristic of the active visual effect may be utilized by the visualization logic 120 to differentiate between varying data values or other characteristics of the respective data point for the z-flower™ cells.

The visualization logic 120 may apply multiple visual indications to a particular cell. The visual indications may be associated with different aspects or dimensions of data points in the data set 151. For example, a first visual indication of a cell may be indicative of the data value of a data point, whereas a second visual indication of a cell may be indicative of a different characteristic of the data point, e.g., in the context of shareholder alignment, the second data characteristic may be indicative of a demographic characteristic of a shareholder providing the data value. The visualization logic 120 may overlay a first visual indication over a second visual indication, such as by overlaying a line pattern or text over a coloring of a particular z-flower™ cell.

The visualization logic 120 may adjust some or all or the applied visual indications of a z-flower™ visualization. For example, the visualization logic 120 may adjust the coloring of a z-flower™ visualization dynamically in response to a user request specifying a varied color scheme or spectrum.

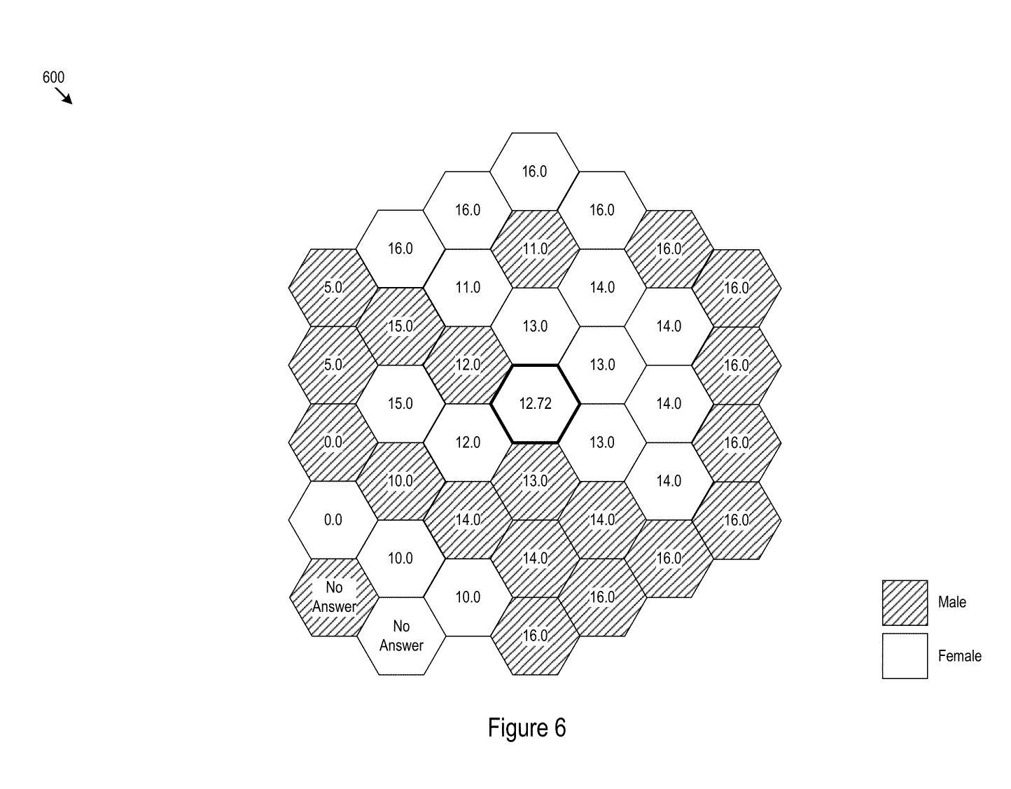

FIG. 6 shows an example of a z-flower™ visualization 600. The z-flower™ visualization 600 shown in FIG. 6 includes a visual indication applied based on a characteristic of the data points of the data set 151 different from the data point value (e.g., stakeholder response value). In particular, the example z-flower™ visualization 600 includes a visual indication applied by the visualization logic 120 based on a gender of the stakeholder respondents. Here, the visualization logic 120 applies a line pattern to the z-flower™ visualization cells based on whether the stakeholder respondent was a male or female. As seen in FIG. 6, cells where the stakeholder respondents are male are indicated through a diagonal line pattern while cells where the stakeholder respondents are female are indicate through an absence of a line pattern, e.g., a white background.

By applying visual indications according to multiple varying characteristics, the visualization logic 120 can generate a z-flower™ visualization that provides increased insight that can be easily and quickly interpreted. In that regard, the z-flower visualization 600 allows a viewer to quickly identify that the distribution of responses between males and females. Moreover, the z-flower™ visualization can indicate pockets of distribution according to the characteristics of the data points (e.g., identify pockets of distributions based on the gender stakeholder responders). As seen in FIG. 6, the viewer can determine that 3 out of the 4 outlier stakeholder responders with response values of 5.0 and 0.0 are male.

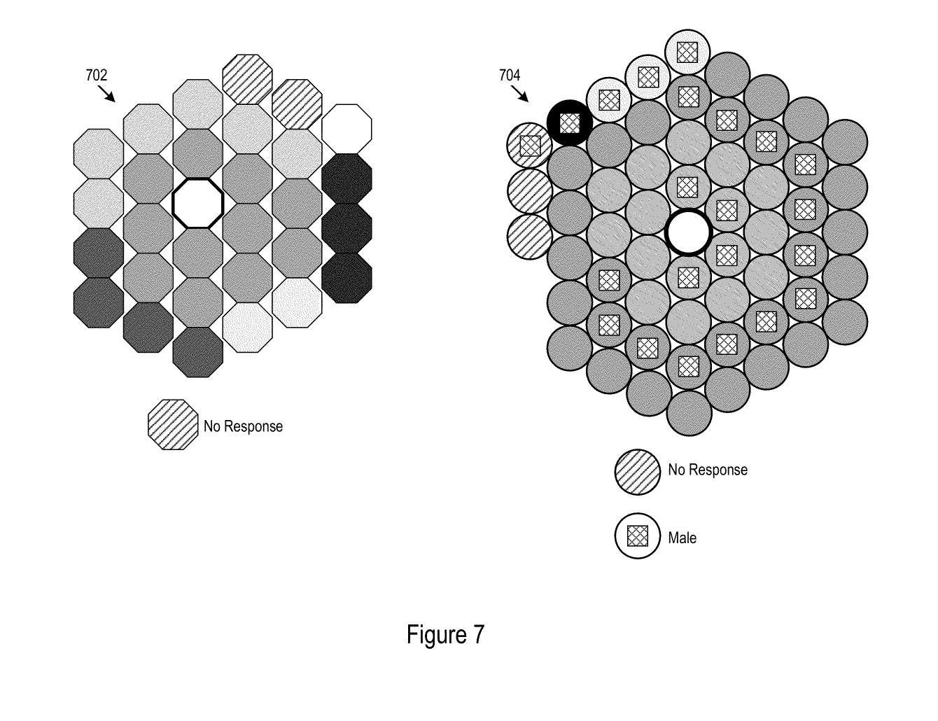

FIG. 7 shows additional examples of z-flower™ visualizations 702 and 704. The exemplary z-flower™ visualizations 702 and 704 provide additional variations that the visualization logic 120 may employ when generating a z-flower™ visualization. The visualization logic 702 may determine a cell shape for the z-flower™ visualization. FIGS. 2-6 illustrate z-flower™ visualizations that include hexagon cell shapes, the z-flower visualization 702 includes octagonal cell shapes, and the z-flower visualization includes circular cell shapes. However, any number of other additional or alternative shapes are contemplated, such as triangles, squares, etc. The visualization logic 120 may employ any cell shape to plot the cells in a spiraling manner, e.g., as specified by the visualization parameters 153. Differing shapes may also illustrate different dimensions, attributes, or characteristics of the data set 151. For example, the visualization logic 120 may determine a cell shape of a first data point of the data set 151 according to a data characteristic associated with the data point and determine a different cell shape for a second data point in the data set 151 according to the data characteristic. As discussed above, data characteristics in the stakeholder alignment context may include stakeholder gender, demographic characteristics, age or age range, etc. The visualization logic 120 may similarly determine a cell shape for a particular cell of a z-flower™ visualization according to one or more data characteristics for any types of data stored or represented in the data set 151

The visualization parameters 153 may specify the number of cells that spiral the initial cell 0. That is, in FIGS. 2-7, the initial cell 0 (indicated with a darkened border) is surrounded by a first spiral ring of 6 directly adjacent cells. However, any number of cells may be specified for the first spiral ring in the z-flower, e.g., the number of directly adjacent cells to the initial cell 0. Similarly, the visualization parameters 153 may specify the number of cells in other spiral rings, e.g., the number of directly adjacent cells to the previous spiral ring.

Z-flower™ visualization 702 provides one example of a z-flower with a coloring visual indication applied by the visualization logic 120 and an octagon cell shape. Z-flower™ visualization 704 provides one example of a z-flower™ visualization with a coloring visual indication applied by the visualization logic 120 indicative of a data value of the data point for each respective data cell with a numerical value, a line pattern visual indication indicative of a null or no data value, a symbol visual indication applied for each cell where the respondent is a male, and no symbol visual indication for each cell where the respondent is a female. While both z-flower™ visualizations 702 and 704 illustrate various visualization parameters 153 the visualization logic 120 may employ, both z-flower™ visualizations in FIG. 7 are characterized by spiraling of data cells from the initial cell in a plotting order determined by the visualization logic 120. Also, in the z-flower™ visualizations 702 and 704, the visualization logic 120 may plot each of the data points in the data set 151 represented by the z-flower™ visualizations 702 and 704.

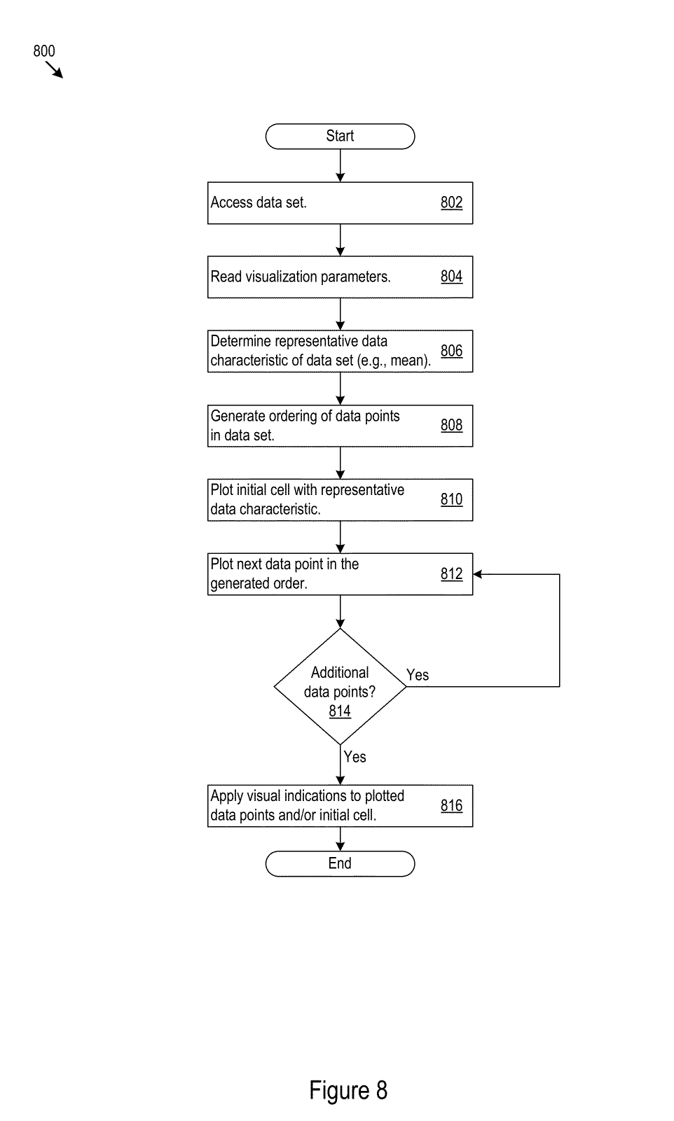

FIG. 8 shows an example of logic 800 that the visualization logic may implement as hardware, software, or firmware. For example, the visualization logic 120 may implement the logic 800 in software as the visualization instructions 152.

The visualization logic 120 may determine or access a data set 151 (step 802). The data set 151 may include discrete or continuous numerical values, for example. The visualization logic 120 may also determine a particular set of data or data points as the data set 151. For instance, the visualization logic 120 may determine the data set 151 to map into a z-flower™ visualization as a particular portion or dimension of a larger data set. The larger data set may include a matrix with 2×2 data dimensions, 3×3, or any other ‘n’ dimension x ‘m’ dimension matrix. The visualization logic 120 may determine the data set 151 to be a set of data with respect to one particular dimension or associated with a particular data point in one of the dimensions. As an illustration, the visualization logic 120 may access a matrix of data with data in two dimensions—a stakeholder dimension and a stakeholder interest dimension (e.g., responses and/or views on stakeholder issues). In this illustration, the visualization logic 120 may access as the data set 151 the stakeholder views/responses for a particular stakeholder issue, which may be referred to as a vector of stakeholders for a particular stakeholder interest. The visualization logic 120 may additionally or alternatively access, as the data set 151, the responses of a particular stakeholder for the stakeholder issue, which may be referred to as a vector of interests for a particular stakeholder. In a similar manner, the visualization logic 120 may access, e.g., extract a, a data set 151 that includes data for a particular dimension, type, or subset of a larger data set.

The visualization logic 120 may read the visualization parameters 153 (step 804). The visualization parameters 153 may specify any number of parameters employed by the visualization logic 120 to generate a z-flower™ visualization, including specifying a cell shape, number and nature of visual indications to apply, a particular representative data characteristic to determine or plot in the z-flower™ visualization, a particular type of data value to consider, plotting order parameters, and more.

The visualization logic 120 may determine one or more representative data characteristics of the data set 151 (step 806). In some implementations, the visualization logic 120 determines the mean and standard deviation of the data set 151 for a data value type (e.g. response values from stakeholder interviews for a particular issue).

The visualization logic 120 may determine a plotting order for the data points in the data set (step 808). The visualization parameters 153 may specify determining the plotting order as an increasing order according to the difference between the data point value of a respective data point and the representative data characteristic. In this example, the visualization logic 120 may determine, for each of the multiple data points in the data set 151, a difference between a data point value of a respective data point and the representative data characteristic. Then, the visualization logic 120 may determine the plotting order by ordering the multiple data points in the data set 151 based on the determined difference for each respective data point. The visualization logic 120 may, for example, determine the plotting order as an ordered vector of stakeholder responses for a particular stakeholder interest (vector of stakeholders for a particular stakeholder interest). As another example, the visualization logic 120 may determine the plotting order as an ordered vector of responses of a particular stakeholder for stakeholder issues (vector of interests for a particular stakeholder).

The visualization logic 120 may plot an initial cell in the z-flower™ visualization with the representative data characteristic (step 810). The visualization logic 120 may visualize the initial cell as a cell with a cell shape specified by the visualization parameters 153 and indicate the initial cell is assigned to the representative data characteristic, e.g., by adding a textual representation of the value of the representative data characteristic to the initial cell. In some implementations, the visualization logic 120 leaves the initial cell blank and/or applies visual indications after plotting the data cells.

The visualization logic 120 may plot the data cells in the z-flower™ visualization. In that regard, the visualization logic 120 may plot the data cells in a spiraling manner, spiraling from the initial cell in an order specified by the plotting order. The visualization logic 120 may plot the next data point in the plotting order (812) and continue to do so until determining that there are no remaining data points in the plotting order (814). The visualization logic 120 may plot the data points in a similar manner with representative data characteristic, e.g., by adding a textual representation of a data value of the data point for each respective cell plotted in the z-flower™ visualization.

The visualization logic 120 may apply one or more visual indications to the plotted data cells or the initial cell (step 816). With respect to the initial cell, the visualization logic 120 may apply a visual indication that is indicative of the representative data characteristic, such as a coloring, symbol, textual indication, or others. The visualization logic 120 may additionally or alternatively apply a visual indication to the initial cell indicative of a second or different representative data characteristic of the data set 151. For instance, the visualization logic 120 may apply a coloring to the initial cell indicative of the standard deviation of the data set 151. With respect to the data cells, the visualization logic 120 may apply one or more visual indications indicative of the data point value of a respective data point plotted in a particular cell, such as a coloring the cell based on the data value associated with the cell. The visualization logic 120 may additionally or alternatively apply one or more visual indications indicative of a different characteristic of the respective data point plotted in a particular cell, such as applying a line pattern according to a different characteristic of the data point plotted in a particular cell. The visualization logic 120 may apply any combination of any of the visual indications described above.

The visualization logic 120 may execute the logic 800 to generate a z-flower™ visualization. Moreover, the visualization logic 120 may generate multiple z-flower™ visualizations for multiple data sets 151 or multiple types of data values in a data set 151. To illustrate, the data set 151 may include stakeholder responses (e.g., data values) for multiple issues. The visualization logic 120 may generate multiple z-flower™ visualizations, e.g., a corresponding z-flower™ visualization for some or all of the multiple issues. The visualization logic 120 may also present the multiple z-flower™ visualizations together as a “z-flower™ garden.” The multiple z-flower™ visualizations may be presented in a tiled display, allowing a viewer to obtain a substantive view of the mapped data set(s) 151, for example by viewing a mapping of multiple stakeholder issues in a z-flower™ visualization garden. In this way, the visualization logic 120 may provide a landscape of data for multiple mapped data sets(s) 151.

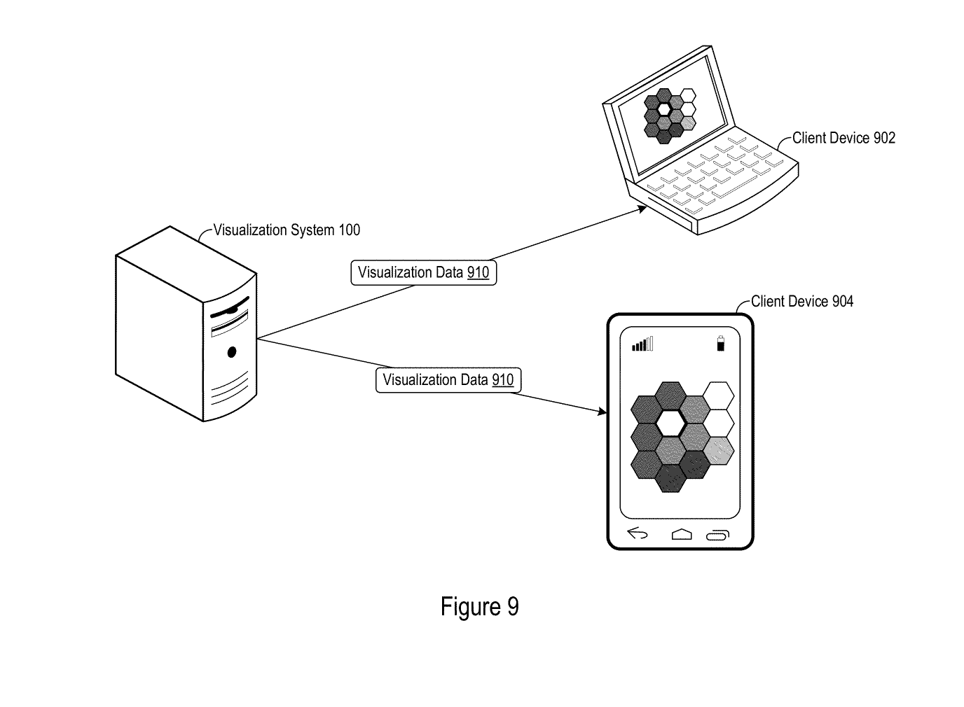

FIG. 9 shows an example of a system 900 for presenting a z-flower™ visualization. The system 900 includes the visualization system 100 and the client devices 902 and 904. The visualization system 100 may transmit visualization data 910 of one or more z-flower™ visualizations for display on any number of devices, such as the client devices 902 and 904. In that regard, the visualization system 100 may active as a backend server for generating the visualization data 910. The visualization data 910 may include any data representation to support display of a z-flower™ visualization.

The visualization system 100 may communicate the visualization data 100 through a direct communication link with the client devices 902 and 904 and/or indirectly through various intermediate network devices and communication networks. For example, the visualization system 100 may send the visualization data 910 through the Internet. The visualization system 100 may act as a web server and host web capabilities for displaying z-flower™ visualizations. The client devices 902 and 904 may access the visualization data 910, for example, through a website or web service hosted by the visualization system 100.

Devices receiving the visualization data 910 and displaying z-flower™ visualizations may take any form. In FIG. 9, the client device 902 is a laptop and the client device 904 is a mobile phone, however any number of additional or alternative electronic devices are contemplated. The client devices 902 and 904 may receive the visualization data 910 and display one or more z-flower™ visualizations in response through a user interface.

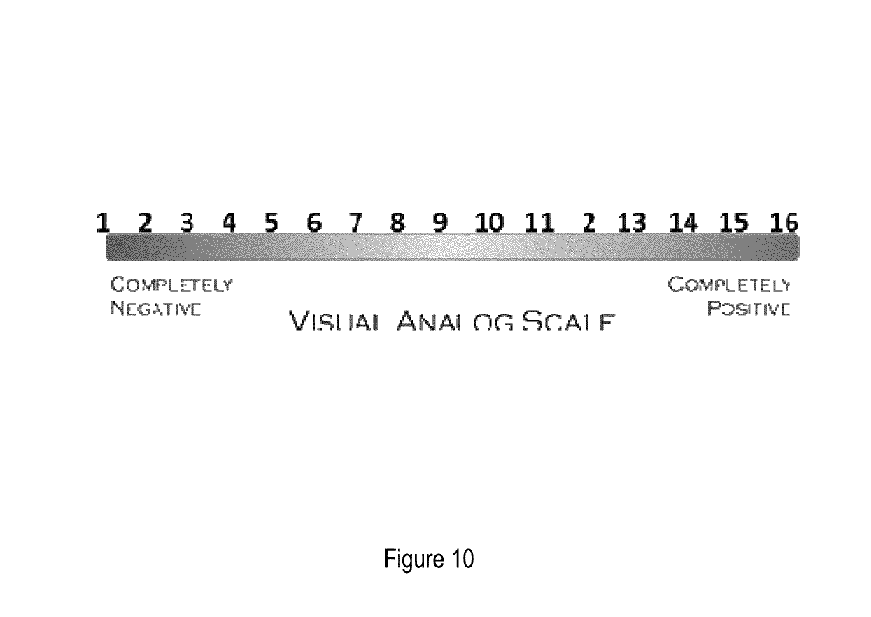

FIG. 10 shows an example of a visual analog scale, which the visualization system 100 may utilize in any of the ways described above and/or in U.S. Provisional Patent Application Ser. No. 61/654,556, which is incorporated by reference herein in its entirety.

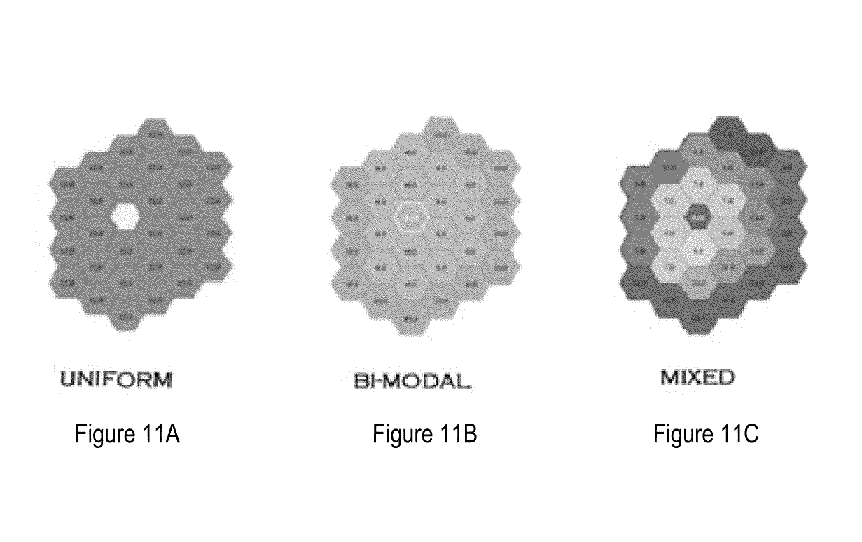

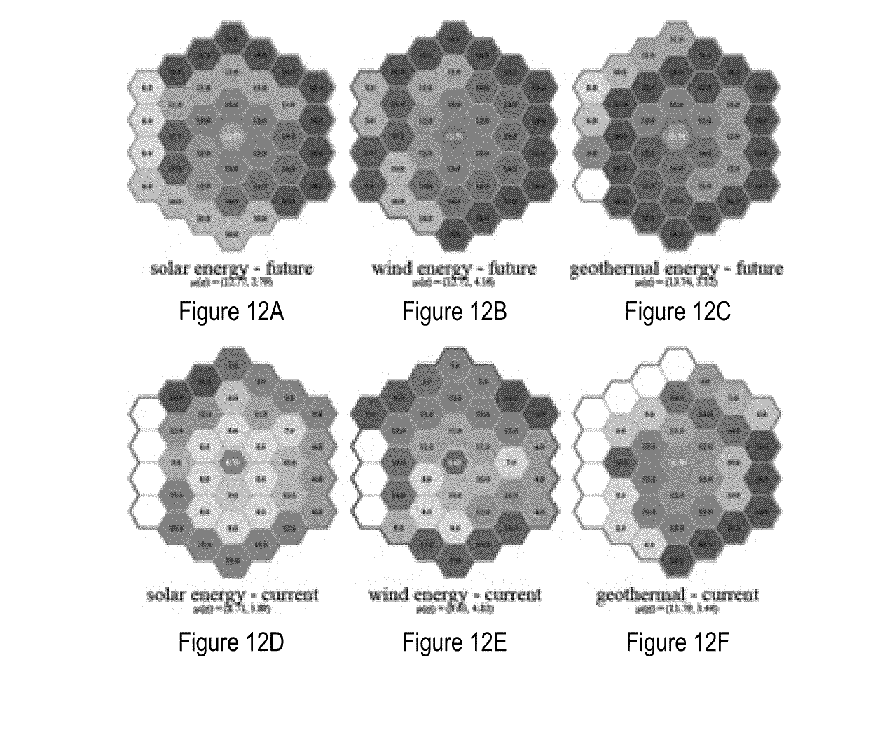

FIGS. 11A-11C, 12A-F, 13, 14A-14B, 15A-15B, and 16A-16B show examples of z-flower™ visualizations. The z-flower™ visualizations shown in any of these Figures may be presented through a user interface of a computing system, mobile device, or other electronic device. For example, the visualization system 100 or the client devices 902 and 904 may present one or more of the z-flower visualizations shown in FIGS. 11A-11C, 12A-F, 13, 14A-14B, 15A-15B, and 16A-16B. Reference is made to U.S. Provisional Patent Application Ser. No. 61/654,556, hereby incorporated by reference herein in its entirety, which describes the z-flower™ visualizations shown FIGS. 11A-11C, 12A-F, 13, 14A-14B, 15A-15B, and 16A-16B in greater detail, e.g., at the discussion of FIGS. 2 and 4-9 of U.S. Provisional Patent Application Ser. No. 61/654,556.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability described above may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the systems and methods have been described, it will be apparent to those of ordinary skill in the art that many more embodiments and implementations are possible within the scope of the systems and methods. Accordingly, the systems and methods are not to be restricted except in light of the attached claims and their equivalents.

What is claimed is:

1. A method for data visualization, the method comprising:
through a visualization system comprising a processor:
accessing a data set comprising multiple data points;
determining a mean of the multiple data points of the data set;
determining, for each of the multiple data points in the data set, a difference between a data point value of a respective data point and the mean; and
generating a visualization of the data set by:
plotting the mean in an initial hexagonal cell; and
plotting each of the multiple data points in the data set in respective hexagonal cells such that the respective hexagonal cells spiral outward from the initial hexagonal cell in an order based on the difference between the data point value of the respective data point and the mean.

2. The method of claim 1, where the order comprises an increasing order of the difference between the data point value of the respective data point and the mean.

3. The method of claim 1, where the order comprises an increasing order of an absolute value of the difference between the data point value of the respective data point and the mean.

4. The method of claim 1, where generating the visualization further comprises:
applying a visual indication to the plotted respective cells, where the visual indication is indicative of the data point value of the respective data point plotted in a particular respective hexagonal cell.

5. The method of claim 4, where generating the visualization further comprises:
coloring the initial hexagonal cell, where the coloring is indicative of a level of variance of the data set.

6. The method of claim 1, where the data set comprises a particular data point without a data point value; and
where plotting each of the multiple data points of the data set in respective hexagonal cells comprises plotting the particular data point at an end of the order.

7. The method of claim 6, further comprising:
applying a visual indication such that the respective hexagonal cell of the particular data point is blank.

8. The method of claim 1, further comprising coloring the respective hexagonal cells according to the data point value of the respective data point plotted in each of the respective hexagonal cells.

9. A system comprising:
a memory storing a data set comprising multiple data points; and
visualization logic in communication with the memory, the visualization logic configured to:
access the data set from the memory;
determine a mean of the data set;
determine, for each of the multiple data points in the data set, a difference between a data point value of a respective data point and the mean;
determine a plotting order for the multiple data points based on the determined difference for the multiple data points; and
generate a visualization of the data set by:
plotting the mean in an initial hexagonal cell; and
plotting each of the multiple data points in the data set in respective hexagonal cells such that the respective hexagonal cells spiral outward from the initial hexagonal cell in the determined plotting order.

10. The system of claim 9, where the visualization logic is configured to determine the plotting order as an increasing order of the difference between the data point value of the respective data point and the mean.

11. The system of claim 9, where the visualization logic is configured to determine the plotting order as an increasing order of an absolute value of the difference between the data point value of the respective data point and the mean.

12. The system of claim 9, where the visualization logic is further configured to generate the visualization by:
coloring the plotted respective hexagonal cells, where the coloring is indicative of the data point value of the respective data point plotted in a particular respective hexagonal.

13. The system of claim 9, where the visualization logic is further configured to generate the visualization by:
coloring the initial hexagonal cell, where the coloring is indicative of a variance level of the data set.

14. The system of claim 9, where the data set comprises a particular data point without a data point value; and
where the visualization logic in configured to determine the plotting order such that the particular data point is at an end of the plotting order.

15. The system of claim 14, where the visualization logic is further configured to generate the visualization by:
applying a visual indication to the respective hexagonal cell of the particular data point such that the respective hexagonal cell of the particular data point is blank.
